(19) United States
(12) Patent Application Publication
(10) Pub. No.: US 2026/0049953 A1
(43) Pub. Date: Feb. 19, 2026

(54) THERMAL DETECTION OF INTERNAL DEFECTS IN SEMICONDUCTOR

(71) Applicant: Orbotech Ltd., Yavne (IL)

(72) Inventors: Elkana Porat, Rehovot (IL); Ronen Yogev, Hulda (IL); Nir Turko, Rehovot (IL); Igor Sakaev, Arad (IL); Yuri Paskover, Binyamina (IL)

(21) Appl. No.: 18/929,008

(22) Filed: Oct. 28, 2024

Related U.S. Application Data
(60) Provisional application No. 63/683,720, filed on Aug. 16, 2024.

(51) Int. Cl. G01N 25/72; G01N 1/44

(52) U.S. Cl. CPC G01N 25/72; G01N 1/44

(57) ABSTRACT

Infrared radiation, and specifically short-wave infrared radiation, may be used as a heat source for an active thermography process in the context semiconductor inspection. Ultrasonic acoustic waves may also be used as a heat source for an active thermography process in the context of semiconductor inspection. Short-wave infrared interference may be used to detect dynamic temperature changes at internal surfaces of a semiconductor, and specifically near a semiconductor direct-bond interface. Either of the short-wave infrared radiation as the heat source or the ultrasonic acoustic waves as the heat source may be combined with the use of short-wave infrared interference to detect dynamic temperature changes, which allows for improved detection resolution. Short-wave infrared interference may also be used to directly detect subsurface voids at the semiconductor direct-bond interface. The short-wave infrared interference may or may not require thermal perturbation.

### CROSS-REFERENCE TO RELATED APPLICATION

The present application claims the benefit under 35 U.S.C. § 119(e) of U.S. Provisional Application Ser. No. 63/683,720, titled “Thermal Detection of Internal Defects in Semiconductor”, filed on Aug. 16, 2024, which is incorporated herein by reference in the entirety.

### TECHNICAL FIELD

The present disclosure generally relates to defect detection, and, more particularly, to defect detection by thermography.

### BACKGROUND

Direct bonding (also called fusion bonding), is a method of adjoining two semiconductor devices without any intermediate solder or adhesive materials. It could be used for the bonding of wafer to wafer, die to wafer, or die to die. One of the drawbacks of this method, is that it is highly susceptive to void formation at the bond interface. The lack of adhesive or solder material means that every surface nonuniformity or contamination prevents intimate contact between the two bond surfaces across a large area, resulting with an internal void. Therefore, high speed, high fidelity void detection in direct bonding is required.

One method to detect subsurface voids is scanning acoustic microscopy (SAM). In scanning acoustic microscopy, ultra-sonic pulses are directed at the subsurface voids, reflected by the subsurface voids, and detected by an ultra-sonic transducer upon reflection. Scanning acoustic microscopy is currently widely used for void detection. However, scanning acoustic microscopy method has limitations, including low through-put, need for immersion, and/or limited resolution (>10 um).

Another method to detect the subsurface voids is thermography. thermography is a non-destructive test (NDT) method, in which a sample's temperature profile in space and/or in time in analyzed to inspect physical properties of the sample. Variations in a temperature profile may be used to detect sub-surface defects in the sample.

Active thermography (AT) is a variation of thermography, where the sample is intentionally heated or cooled as part of the measurement process. In active thermography, a pulsed or modulated heat source (e.g. flash lamp, laser light, radio-frequency radiation, acoustic heating, inductive heating, Joule heating, or others) is applied on the sample. As the applied source propagates through the material, the applied source interacts with internal defects, which will heat up or cool down at a different rate than the surrounding material. Next, an infrared camera captures the surface temperature changes over time. Finally, the spatially resolved, time dependent, temperature profile is analyzed to identify sub-surface defects. Active thermography may be faster than scanning acoustic microscopy and does not require immersion. However, due to heat diffusion within the sample, active thermography is also limited to subsurface voids with lateral dimension comparable or larger than the depth of the defect.

Therefore, it would be advantageous to provide a device, system, and method that cures the shortcomings described above.

### SUMMARY

An active thermographic system is described, in accordance with one or more embodiments of the present disclosure. The active thermographic system may include: a stage configured to support a direct-bonded stack, wherein the direct-bonded stack includes an upper semiconductor device and a lower semiconductor device, wherein the upper semiconductor device and the lower semiconductor device are coupled by a direct bond, wherein the direct bond may include a subsurface void; a heat source configured to heat the direct bond; an imaging subsystem configured to generate a plurality of infrared images of the direct bond from collected-infrared light; and a controller, wherein the controller includes one or more processors configured to execute program instructions maintained in memory, the program instructions causing the one or more processors to: receive the plurality of infrared images from the imaging subsystem; and detect the subsurface void in the direct bond based on the plurality of infrared images.

An optical inspection system is described, in accordance with one or more embodiments of the present disclosure. The optical inspection system may include: a stage configured to support a direct-bonded stack, wherein the direct-bonded stack includes an upper semiconductor device and a lower semiconductor device, wherein the upper semiconductor device and the lower semiconductor device are coupled by a direct bond, wherein the direct bond may include a subsurface void; an imaging subsystem configured to generate a plurality of infrared images of the direct bond from collected-infrared light, wherein the imaging subsystem may be configured to illuminate the direct bond with infrared illumination, wherein the infrared illumination reflects or emits from the direct bond as the collected-infrared light, wherein the infrared illumination is one of near-infrared illumination or short-wave infrared illumination, wherein the imaging subsystem includes: an illumination source configured to generate the infrared illumination and direct the infrared illumination along an illumination pathway to the direct-bonded stack and reflect as the collected-infrared light, wherein the collected-infrared light is formed via interferometry; a detector, wherein the collected-infrared light is directed to the detector along a collection pathway including an objective lens, wherein the detector is configured to receive the collected-infrared light and generate the plurality of infrared images; and a controller, wherein the controller includes one or more processors configured to execute program instructions maintained in memory, the program instructions causing the one or more processors to: receive the plurality of infrared images from the imaging subsystem; and detect the subsurface void in the direct bond based on the plurality of infrared images.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1 depicts a block diagram of an active thermographic system, in accordance with one or more embodiments of the present disclosure.

FIG. 2 depicts a block diagram of the active thermographic system with a light-based heat source, in accordance with one or more embodiments of the present disclosure.

FIG. 3A depicts a block diagram of the active thermographic system with a NIR-imaging subsystem or a SWIR-imaging subsystem, in accordance with one or more embodiments of the present disclosure.

FIG. 3B depicts a partial cross-section of a direct-bonded stack with an upper semiconductor device acting as a shear plate of the active thermographic system, in accordance with one or more embodiments of the present disclosure.

FIG. 4 depicts a block diagram of the active thermographic system with a NIR-imaging subsystem or a SWIR-imaging subsystem including an objective lens which is configured to translate, in accordance with one or more embodiments of the present disclosure.

FIG. 5 depicts a flow diagram of a method, in accordance with one or more embodiments of the present disclosure.

FIG. 6 depicts a block diagram of the active thermographic system configured as a double-path interferometer with a reference pathway, in accordance with one or more embodiments of the present disclosure.

FIG. 7 depicts a flow diagram of a method, in accordance with one or more embodiments of the present disclosure.

FIG. 8 depicts a block diagram of an optical inspection system without a heat source, in accordance with one or more embodiments of the present disclosure.

### DETAILED DESCRIPTION

The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure. Reference will now be made in detail to the subject matter disclosed, which is illustrated in the accompanying drawings.

Embodiments of the present disclosure are described herein that utilize and/or improve some variations of active thermography, to account for small defects in obscured semiconductor interfaces. The combination of some of the embodiments are suggested to be combined, but each of them can also be used independently. An embodiment is the use of infrared (IR) radiation, and specifically short-wave infrared (SWIR) radiation, as a heat source for the active thermography process in the context of semiconductor inspection. Another embodiment is the use of ultrasonic acoustic waves as a heat source for the active thermography process in the context of semiconductor inspection. Another embodiment is the use of short-wave infrared interference to detect dynamic temperature changes at internal surface of a semiconductor, and specifically near a semiconductor direct-bonded interface. Another embodiment is the combination of either of the short-wave infrared radiation as the heat source or the ultrasonic acoustic waves as the heat source with the use of short-wave infrared interference to detect dynamic temperature changes, which allows for improved detection resolution. Another embodiment is the use of short-wave infrared interference to directly detect defects in obscured internal surfaces of a semiconductor, and specifically voids at semiconductor direct-bonded interface. The short-wave infrared interference may or may not require thermal perturbation. Any of the embodiments may be used to improve a speed and/or fidelity of a defect-detection process, utilizing an inspection and review procedure.

U.S. Patent Number U.S. Pat. No. 7,259,869B2, titled “System and method for performing bright field and dark field optical inspection”; U.S. Patent Number U.S. Pat. No. 9,322,715B2, titled “Three-dimensional hot spot localization”; U.S. Patent Number U.S. Pat. No. 10,234,402B2, titled “Systems and methods for defect material classification”; U.S. Patent Publication Number US20100074515A1, titled “Defect Detection and Response”; are each incorporated herein by reference in the entirety.

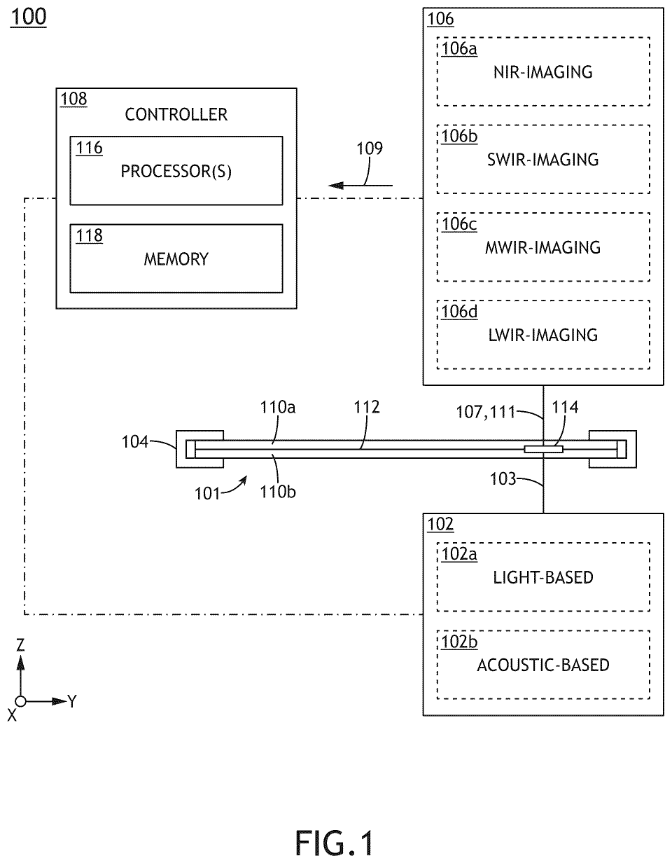

FIG. 1 depicts an active thermographic system 100, in accordance with one or more embodiments of the present disclosure. The active thermographic system 100 may include a heat source 102, a stage 104, an imaging subsystem 106, and/or a controller 108.

A direct-bonded stack 101 may be a stack which is direct bonded. For example, the direct-bonded stack 101 may be a die-to-die stack, die-to-wafer stack, wafer-to-wafer stack, die-to-interposer stack, a package, a 2.5D integration, a 3D integration, a multi-chip module, or the like.

The direct-bonded stack 101 may include semiconductor devices 110. The semiconductor devices 110 may be dies, wafers, interposers, or the like. The semiconductor devices 110 may be made of a semiconductor material, such as, but not limited to, silicon, glass, organic material, or the like.

The direct-bonded stack 101 may include upper semiconductor devices 110a and lower semiconductor devices 110b. The direct-bonded stack 101 may include one or more of the upper semiconductor devices 110a. For example, the direct-bonded stack 101 may include multiple of the upper semiconductor devices 110a for each of the lower semiconductor devices 110b, where the direct-bonded stack 101 is a 2.5D integration. The upper semiconductor devices 110a and the lower semiconductor devices 110b may include thicknesses. The thicknesses of the upper semiconductor devices 110a and the lower semiconductor devices 110b may or may not be the same.

The upper semiconductor devices 110a and the lower semiconductor devices 110b may be coupled by a direct bond 112. The direct bond 112 may be between the upper semiconductor devices 110a and the lower semiconductor devices 110b. The direct bond 112 may be a permanent bond that combines a dielectric bond with a metallization layer to form interconnections between the upper semiconductor devices 110a and the lower semiconductor devices 110b (e.g., a hybrid bond).

The semiconductor devices 110 may include metallization layers (not depicted). The metallization layers may form one or more integrated circuits. The metallization layers may be disposed adjacent to and/or form a portion of the direct bond 112. For example, the metallization layers may connect the semiconductor devices 110. The metallization layers may also be an internal surface within the semiconductor devices 110.

The direct bond 112 may include a subsurface void 114. The subsurface void 114 may be an airgap between the upper semiconductor devices 110a and the lower semiconductor devices 110b. For example, the subsurface void 114 may be an airgap in wafer-to-wafer and die-to-wafer direct bonding. The subsurface void 114 may also be referred to as a bubble. The subsurface void 114 may be between the metallization layers and/or the dielectric of the upper semiconductor devices 110a and the lower semiconductor devices 110b.

Dimensions of the subsurface void 114 may include a thickness and/or a width. The thickness of the subsurface void 114 may be on the order from tens of nanometers to several micrometers. The width of the subsurface void 114 may be on the order of tens or hundreds of micrometers. Thus, the width of the subsurface void 114 may be one or two orders of magnitude larger than the thickness of the subsurface void 114. The scale of the width relative to the thickness of the subsurface void 114 may raise challenges when detecting the subsurface void 114.

The direct-bonded stack 101 may be a sample under test (SUT) by the active thermographic system 100. The active thermographic system 100 may be configured to detect the subsurface void 114 in the direct bond 112 of the direct-bonded stack 101. The active thermographic system 100 may accommodate for the scale of the width relative to the thickness of the subsurface void 114 when detecting the subsurface void 114. The active thermographic system 100 may detect the subsurface void 114 using the heat source 102, the stage 104, the imaging subsystem 106, and/or the controller 108.

The active thermographic system 100 may include the heat source 102. The heat source 102 may be configured to heat the direct-bonded stack 101. For example, the heat source 102 may be configured to heat the direct bond 112. The heat source 102 may be configured to apply heat energy to the direct-bonded stack 101. The heat energy may heat the direct-bonded stack 101. The heat source 102 may be a light-based heat source 102a and/or an acoustic-based heat source 102b. The heat energy of the light-based heat source 102a and the acoustic-based heat source 102b may be infrared radiation 103a and acoustic waves 103b, respectively. The infrared radiation 103a and/or the acoustic waves 103b may heat the direct-bonded stack 101. For example, the infrared radiation 103a may generate heat in the direct bond 112. The subsurface void 114 may resist transfer of the heat generated the infrared radiation 103a in the direct bond 112. By way of another example, the subsurface void 114 may be heated in response to the acoustic waves 103b. Thus, the active thermographic system 100 may use the infrared radiation 103a and/or the acoustic waves 103b for heating in and/or around the subsurface void 114 at sub-surface locations in the direct-bonded stack 101 for subsequent detection by thermography.

The active thermographic system 100 may be configured in opposite side configuration. The light-based heat source 102a and the imaging subsystem 106 may be disposed on opposing sides of the direct-bonded stack 101. For example, the light-based heat source 102a may heat the direct-bonded stack 101 from a bottom surface of the direct-bonded stack 101 and the imaging subsystem 106 may detect the subsurface void 114 from a top surface of the direct-bonded stack 101. The infrared radiation 103a may irradiate the bottom of the direct bond 112 where the active thermographic system 100 is configured in opposite side configuration.

Although the active thermographic system 100, is described as configured in opposite side configuration with the light-based heat source 102a and the imaging subsystem 106 disposed on opposing sides, this is not intended as a limitation of the present disclosure. It is contemplated that the light-based heat source 102a and the imaging subsystem 106 may be disposed on a same side of the direct-bonded stack 101. Where the heat source 102 is the light-based heat source 102a, light in a path between the direct-bonded stack 101, the light-based heat source 102a, and the imaging subsystem 106 may be split and/or combined using a splitter/combiner, a dichroic mirror, or the like. Additionally, the infrared radiation 103a and the collected-infrared light 107 may include different wavelengths to prevent interferometry between the infrared radiation 103a and the collected-infrared light 107. However, it is contemplated that the active thermographic system 100 may detect the subsurface void 114 more easily and with a higher sensitivity using the opposite side configuration.

Infrared (IR) may include near-infrared (NIR), short-wave infrared (SWIR), mid-wave infrared (MWIR), and/or long-wave infrared (LWIR). Near-infrared (NIR) may include wavelengths from 0.75 to 1.4 micrometers. Short-wave infrared (SWIR) may include wavelengths from 1.4 to 3 micrometers. Mid-wave infrared (MWIR) may include wavelengths from 3 to 8 micrometers. Long-wave infrared (LWIR) may include wavelengths from 8 to 15 micrometers.

Light may propagate through the semiconductor devices 110. The semiconductor devices 110 may be transparent or partially transparent to IR light (e.g., infrared radiation 103a, infrared illumination 111, and/or collected-infrared light 107). For example, the semiconductor devices 110 may be partially transparent to NIR light. The NIR light may be volumetrically absorbed by the semiconductor devices 110 over the thickness of the semiconductor devices 110 during propagation through the semiconductor devices 110. The semiconductor devices 110 may be transparent to infrared (IR) light. For example, the semiconductor devices 110 may be transparent to SWIR light, MWIR light, and/or LWIR light. The IR light (e.g., NIR, SWIR, MWIR, and/or LWIR) may be absorbed by the layers near the direct bond 112 of the direct-bonded stack 101. Heat from the direct bond 112 may then diffuse into the semiconductor devices 110.

The active thermographic system 100 may be configured for active thermography (AT). Active thermography may include actively applying the heat source 102 to heat the direct bond 112. Active thermography may include lock-in thermography (LIT), pulsed thermography, vibro-thermography, and the like. The heat source 102 may actively heat the direct-bonded stack 101 using lock-in thermography, pulsed thermography, and/or vibro-thermography. The active thermographic system 100 may be configured for lock-in thermography and/or pulsed thermography where the heat source 102 is the light-based heat source 102a. The active thermographic system 100 may be configured for vibro-thermography where the heat source 102 is the acoustic-based heat source 102b.

The light-based heat source 102a may be modulated to actively heat the direct-bonded stack 101. For example, the light-based heat source 102a may be pulse modulated and/or sinusoidally modulated. In lock-in thermography, the light-based heat source 102a may be sinusoidally modulated to actively heat the direct-bonded stack 101. In pulsed thermography, the light-based heat source 102a may be pulse modulated to actively heat the direct-bonded stack 101. The modulation of the light-based heat source 102a may include a modulation duration, modulation frequency, and/or modulation phase. The frequency of the sinusoidal modulation may be between 1 Hz and 300 Hz. The duration of the pulse modulation may be between 1 millisecond and 500 milliseconds between dwells. The dwells may or may not include a same duration as the pulses. The irradiation power density of the light-based heat source 102a may be enough to heat the direct bond 112 by at least 0.01 K within a single heat pulse or modulation cycle.

In embodiments, the heat source 102 may be the acoustic-based heat source 102b. The acoustic-based heat source 102b may also be referred to as an ultrasonic transducer. Vibro-thermography using the acoustic-based heat source 102b may be used for defect detection in the semiconductor devices 110, and specifically for detecting the subsurface void 114 in the direct bond 112.

The acoustic-based heat source 102b may be coupled to the direct-bonded stack 101. The acoustic-based heat source 102b may be coupled to the direct-bonded stack 101 directly (e.g., to a bottom surface of the lower semiconductor devices 110b, to a top surface of the upper semiconductor devices 110a, to edges of the semiconductor devices 110), via the stage 104, local immersion (e.g., partial (bottom-side) liquid immersion), through air (e.g., near-field or far-field air coupling), or the like. The stage 104 may include an acoustic coupling module (e.g., a clamp or a local immersion port) where the heat source 102 is the acoustic-based heat source 102b.

The acoustic waves 103b may be ultrasonic acoustic waves. The acoustic waves 103b may be sensitive to discontinuities in the direct-bonded stack 101. The acoustic waves 103b may interact with the subsurface void 114 rather than the semiconductor devices 110. Thus, the acoustic waves 103b may heat the subsurface void 114. The acoustic waves 103b may propagate through the semiconductor devices 110 and dissipate into heat only at the subsurface void 114. The acoustic waves 103b may dissipate into heat at the subsurface void 114 due to void deformation, resulting in friction, enclosed gas compression, elasto-plastic deformation, and possibly other mechanisms. Vibro-thermography may be used to detect the subsurface void 114 which is smaller than a thermal diffusion length (μ) of the subsurface void 114, as the heat is deposited only at the subsurface void 114.

The acoustic-based heat source 102b may be configured to perform any type of vibro-thermography, such as, but not limited to, resonance vibro-thermography and/or off-resonance vibro-thermography. Resonance vibro-thermography may advantage on local defect acoustic resonance (LDR) to increase the efficiency of heat dissipation into the subsurface void 114. A resonance frequency for the subsurface void 114 in the direct bond 112 may be inversely proportional to the size of the subsurface void 114.

The stage 104 may support and/or position the direct-bonded stack 101. The stage 104 may include any type of stage for positioning the direct-bonded stack 101 including, but not limited to, a linear translation stage, a rotational translation stage, or a translation stage with adjustable tip and/or tilt. The stage 104 may include a wafer holder. The direct-bonded stack 101 may be held in the wafer holder such that the inner diameter of the direct-bonded stack 101 may be heated by the heat source 102. For example, the wafer holder may include an opening that encompasses at least 90% of the inner diameter of the direct-bonded stack 101 for providing access to the inner diameter. The stage 104 may include a tray. The tray may be made of a material transparent to the irradiation from the heat source 102. For example, the tray may be made of glass. The direct-bonded stack 101 may be placed on the tray such that the direct-bonded stack 101 may be heated by the heat source 102. The stage 104 include an XY motorized stage. The XY motorized stage may bring any part of the direct-bonded stack 101 over the heat source and/or under the imaging subsystem 106. The stage 104 may also include a Z stage. The Z stage may bring the direct-bonded stack 101 to a focal plane of the imaging subsystem 106.

The imaging subsystem 106 may generate infrared images 109 of the direct bond 112 from collected-infrared light 107. The infrared images 109 may include a temperature profile of the upper semiconductor devices 110a. The temperature profile may also be referred to as a thermal profile. The temperature profile of the upper semiconductor devices 110a may vary based on the presence or absence of the subsurface void 114. For example, the temperature profile may vary less over the sinusoidal cycles above the subsurface void 114 in lock-in thermography or exhibit a measurable delay in the thermal response. By way of another example, the temperature profile may be colder above the subsurface void 114 in pulse thermography or the temperature rise may come at a delay with respect to un-voided areas. By way of another example, the temperature profile may be hotter above the subsurface void 114 in vibro-thermography.

The controller 108 may include processors 116 configured to execute program instructions maintained on memory 118, the program instructions causing the controller 108 to perform one or more of the methods of the present disclosure.

The processors 116 may include any processor or processing element known in the art. For the purposes of the present disclosure, the term “processor” or “processing element” may be broadly defined to encompass any device having one or more processing or logic elements (e.g., one or more micro-processor devices, one or more application specific integrated circuit (ASIC) devices, one or more field programmable gate arrays (FPGAs), or one or more digital signal processors (DSPs)). In this sense, the one or more processors may include any device configured to execute algorithms and/or instructions (e.g., program instructions stored in memory). In one embodiment, the one or more processors may be embodied as a desktop computer, mainframe computer system, workstation, image computer, parallel processor, networked computer, or any other computer system configured to execute a program configured to operate or operate in conjunction with the systems, as described throughout the present disclosure.

The memory 118 may include any storage medium known in the art suitable for storing program instructions executable by the associated one or more processors. For example, the memory medium may include a non-transitory memory medium. By way of another example, the memory medium may include, but is not limited to, a read-only memory (ROM), a random-access memory (RAM), a magnetic or optical memory device (e.g., disk), a magnetic tape, a solid-state drive and the like. It is further noted that memory medium may be housed in a common controller housing with the one or more processors. In one embodiment, the memory medium may be located remotely with respect to the physical location of the one or more processors and controller. For instance, the one or more processors of controller may access a remote memory (e.g., server), accessible through a network (e.g., internet, intranet and the like).

The controller 108 may be configured to modulate the light-based heat source 102a. The controller 108 may include a chopper function, or the like, for modulating the heat source 102.

The controller 108 may synchronize the heat source 102 and the imaging subsystem 106. For example, the imaging subsystem 106 may be controlled to synchronize the acquisition of the infrared images 109 with the frequency and/or phase of the heat source 102.

The controller 108 may receive the infrared images 109 from the imaging subsystem 106. The controller 108 may detect the subsurface void 114 in the direct bond 112 based on the infrared images 109. The controller 108 may detect the subsurface void 114 using any suitable technique. The controller 108 may detect the subsurface void 114 based on interference fringes in the infrared images 109. In the case of lock-in thermography, the controller 108 may detect the subsurface void 114 in the direct bond 112 based on the infrared images 109 by analyzing the thermal data either in the time domain or in the temporal frequency domain, e.g. by performing a Fourier transform the infrared images 109 to detect the subsurface void 114. The Fourier transform may determine phase images and amplitude images. The phase images and amplitude images may be compared with reference images, with a threshold, to detect the differences indicate the subsurface void 114. In the case of pulse thermography, the controller 108 may detect the presence of the subsurface void 114 in the direct bond 112 based on the infrared images 109 by comparing the thermal response in the infrared images 109 to a cooling profile.

The imaging subsystem 106 may be a NIR-imaging subsystem 106a, a SWIR-imaging subsystem 106b, an MWIR-imaging subsystem 106c, and/or a LWIR-imaging subsystem 106d. The collected-infrared light 107 may be NIR collected-infrared light, SWIR collected-infrared light, MWIR collected-infrared light, and/or LWIR collected-infrared light. The NIR-imaging subsystem 106a, the SWIR-imaging subsystem 106b, the MWIR-imaging subsystem 106c, and/or the LWIR-imaging subsystem 106d may acquire the infrared images 109 from the NIR collected-infrared light, SWIR collected-infrared light, MWIR collected-infrared light, and/or LWIR collected-infrared light, respectively.

In embodiments, the active thermographic system 100 may use the thermal-radiation of the direct bond 112 when detecting the subsurface void 114. The collected-infrared light 107 may be emitted by the direct bond 112 in response to being heated by the heat source 102. The thermal-radiation may refer to the collected-infrared light 107 being emitted as radiation in the IR wavelengths due to the temperature of the direct bond 112. The direct-bonded stack 101 may emit the radiation. For example, the direct-bonded stack 101 may emit the collected-infrared light 107 as MWIR and/or LWIR. The MWIR-imaging subsystem 106c and/or the LWIR-imaging subsystem 106d may measure the MWIR and LWIR, respectively, when detecting the subsurface void 114 from the thermal-radiation of the direct bond 112. The direct-bonded stack 101 may not emit the radiation as NIR or SWIR unless the subsurface void 114 is at high temperatures (e.g., above about 100° C. for SWIR, above several hundreds of ° C. for NIR) which may damage the direct-bonded stack 101. Thus, the NIR-imaging subsystem 106a and/or the SWIR-imaging subsystem 106b may not use the thermal-radiation of the direct bond 112 when detecting the subsurface void 114.

Although the active thermographic system 100 is described as using the thermal-radiation of the direct bond 112, this is not intended as a limitation of the present disclosure. Instead of using the thermal-radiation of the direct bond 112, the imaging subsystem 106 may illuminate the direct bond 112 with infrared illumination 111. The infrared illumination 111 may be NIR illumination and/or SWIR illumination. The infrared illumination 111 may reflect (e.g., scatter, diffract, and the like) from the direct bond 112 and be received as the collected-infrared light 107. The active thermographic system 100 may then detect the thermal profile indirectly based on a change in the optical properties of the upper semiconductor devices 110a caused by the thermal profile.

The infrared illumination 111 may include one or more optical properties. For example, the optical properties of the infrared illumination 111 may include, but are not limited to, an angle-of-incidence (AOI), a collection angle of illumination reflected from the direct-bonded stack 101, one or more wavelengths, and the like. The infrared illumination 111 may include any range of selected wavelengths in NIR and/or SWIR. For example, the infrared illumination 111 may be between 1 and 1.7 micrometers.

The infrared illumination 111 may include a power which is sufficiently low such that the infrared illumination 111 does not measurably increase the temperature of the direct-bonded stack 101. For example, the power of the infrared illumination 111 may be on the order of milliwatts or tens of milliwatts. The infrared illumination 111 may be much less powerful than the heat energy from the heat source 102. For example, the power of the infrared illumination 111 may be two or more orders of magnitude smaller than the power of the heat energy from the heat source 102.

The collected-infrared light 107 may be NIR light and/or SWIR light. The NIR-imaging subsystem 106a and/or the SWIR-imaging subsystem 106b may be configured to illuminate the direct bond 112 with the infrared illumination 111 and receive the collected-infrared light 107. The infrared illumination 111 and the collected-infrared light 107 may each be NIR light or SWIR light, where the imaging subsystem 106 is the NIR-imaging subsystem 106a or the SWIR-imaging subsystem 106b, respectively. The infrared illumination 111 may be collimated before reaching the direct-bonded stack 101.

The collected-infrared light 107 may be formed via interferometry. For example, the imaging subsystem 106 may be configured for shearing interferometry where the collected-infrared light 107 may be formed from interferometry between portions of light reflected by and transmitted by the upper semiconductor devices 110a. By way of another example, the imaging subsystem 106 may be configured for double-path interferometry where the collected-infrared light 107 may be formed from interferometry with a reference beam.

The refractive index of the upper semiconductor devices 110a at the wavelength of the collected-infrared light 107 may vary with the temperature of the upper semiconductor devices 110a. Changes in the refractive index of the upper semiconductor devices 110a may correspond to changes in the temperature, which corresponds to the presence of the subsurface void 114. Thus, the refractive index of the upper semiconductor devices 110a may be used to detect the subsurface void 114. The NIR-imaging subsystem 106a and/or the SWIR-imaging subsystem 106b may use the change in the refractive index of the semiconductor devices 110 when detecting the subsurface void 114. The change in the refractive index may be relatively small. The NIR-imaging subsystem 106a and/or the SWIR-imaging subsystem 106b may be configured as an interferometer by which the NIR-imaging subsystem 106a and/or the SWIR-imaging subsystem 106b may detect the change in the refractive index. The collected-infrared light 107 may be an interference signal based on interference of the infrared illumination 111. The NIR-imaging subsystem 106a and/or the SWIR-imaging subsystem 106b may then detect dynamic temperature changes at the subsurface void 114 within the direct-bonded stack 101.

The controller 108 may cause the imaging subsystem 106 to generate the infrared images 109 as a step-and-repeat process, a scanning process, or the like. The stage 104 may move the direct-bonded stack 101 under a field-of-view (FOV) of the NIR-imaging subsystem 106a and/or the SWIR-imaging subsystem 106b. The field-of-view may refer to the field at which the NIR-imaging subsystem 106a and/or the SWIR-imaging subsystem 106b is configured to illuminate with the infrared illumination 111 and collect the collected-infrared light 107. The stage 104 may move the direct-bonded stack 101 under the field-of-view as part of a step-and-repeat process where the infrared images 109 are generated before moving the direct-bonded stack 101 to a new position for generating additional of the infrared images 109. Alternatively, the stage 104 may scan the direct-bonded stack 101 under the infrared illumination 111 such that the direct-bonded stack 101 moves continually while generating the infrared images 109.

One advantage of the NIR-imaging subsystem 106a and/or the SWIR-imaging subsystem 106b, as compared to the MWIR-imaging subsystem 106c, may be that the NIR-imaging subsystem 106a and/or the SWIR-imaging subsystem 106b may be less expensive than the MWIR-imaging subsystem 106c. One advantage of the NIR-imaging subsystem 106a and/or the SWIR-imaging subsystem 106b, as compared to the LWIR-imaging subsystem 106d, may be that the NIR-imaging subsystem 106a and/or the SWIR-imaging subsystem 106b may generate the infrared images 109 faster and with higher resolution than LWIR-imaging subsystem 106d.

The heat source 102 may be used with any configuration of the imaging subsystem 106. For example, the heat source 102 may be used with any of the NIR-imaging subsystem 106a, the SWIR-imaging subsystem 106b, the MWIR-imaging subsystem 106c, and/or the LWIR-imaging subsystem 106d. Similarly, the imaging subsystem 106 may be used with any configuration of the heat source 102. For example, the imaging subsystem 106 may be used with any of the light-based heat source 102a and/or the acoustic-based heat source 102b. Thus, all combinations of the light-based heat source 102a and/or the acoustic-based heat source 102b are contemplated with the NIR-imaging subsystem 106a, the SWIR-imaging subsystem 106b, the MWIR-imaging subsystem 106c, and/or the LWIR-imaging subsystem 106d are contemplated. The combinations of thermal detection and interference detection may increase the fidelity of each of the methods separately.

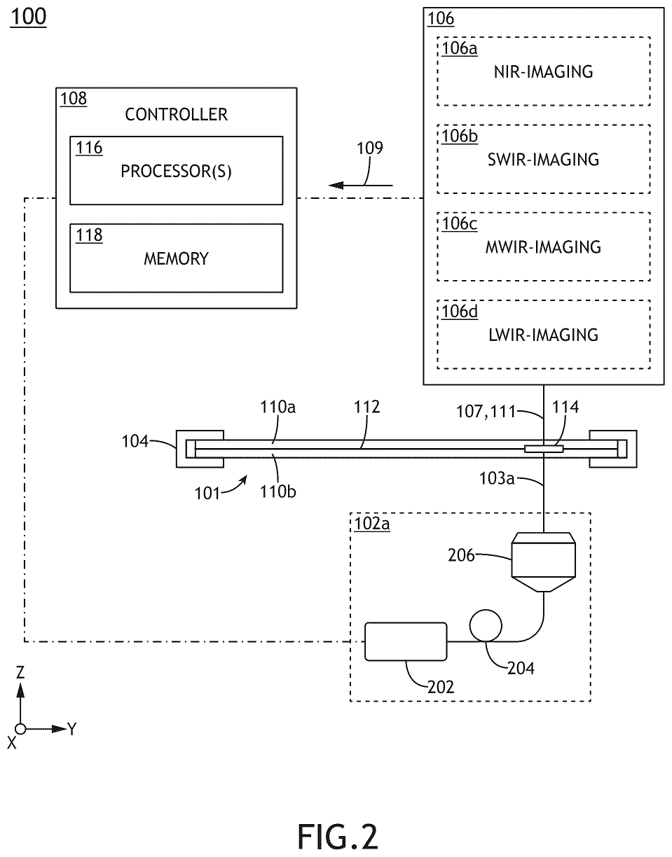

FIG. 2 depicts the active thermographic system 100 with the light-based heat source 102a, in accordance with one or more embodiments of the present disclosure. In this example of the active thermographic system 100, the heat source 102 is the light-based heat source 102a.

The light-based heat source 102a may include a light source 202. The light source 202 may be a coherent light source or an incoherent light source. For example, the light source 202 may be a laser, a light-emitting diode (LED), a lamp, or another coherent or incoherent light source. The infrared radiation 103a may be coherent radiation or incoherent radiation.

The light source 202 may be a NIR light source or a SWIR light source, a MWIR light source, or a LWIR light source. The infrared radiation 103a may be NIR radiation, SWIR radiation, MWIR radiation, or LWIR radiation where the light source 202 is the NIR light source, the SWIR light source, the MWIR light source, or the LWIR light source, respectively. For example, the light source 202 may be a NIR laser, a NIR LED, a SWIR laser, a SWIR LED, a MWIR lamp, a LWIR lamp, or any other NIR or IR light source.

A spatial resolution of the active thermographic system 100 may be defined by a thermal diffusion length (μ). The thermal diffusion length (μ) may represent how far heat may propagate within the direct-bonded stack 101 during a specific time interval.

For example, the thermal diffusion length (μ) in lock-in thermography where the heat source 102 is sinusoidally modulated may be defined by:

$$μ = \sqrt{\frac{α}{π {f}_{lock - in}}}$$

where f_{lock-in} is the modulation frequency of the heat source 102 and a is the thermal diffusivity of the direct-bonded stack 101. The relationship between thermal diffusion length (μ), thermal diffusivity (α) and time is also relevant, with appropriate modification, to other types of active thermography, such as pulsed thermography.

The implication of the above relation is that higher detection resolution requires higher temporal resolution of the thermal detection. In addition, since the thermal diffusion length (μ) controls both the lateral resolution and the detection depth of active thermography, the ability to detect the subsurface void 114 is limited to dimensions comparable to the thickness of the direct-bonded stack 101. If the thermal diffusion length (μ) is too large, then the subsurface void 114 with a small size may not be detected. Thus, one limitation with thermography may be that the resolution is related to the speed and/or frequency that the direct-bonded stack 101 is heated and cooled. If heated with a higher speed and/or frequency, then there is less time for thermal wave to expand through the direct-bonded stack 101. For example, if the thermal diffusion length (μ) is too large, then the thermal perturbation will disappear because the thermal perturbation will diffuse. The thermal diffusion length (μ) may be made small by increasing the frequency of the perturbation. However, increasing the frequency decreases the thermal diffusion length (μ). Thus, if the subsurface void 114 is very deep within the thickness of the direct-bonded stack 101, the active thermographic system 100 cannot detect the subsurface void 114 unless the thermal diffusion length is large enough. The diffusion is both lateral and through the depth. So laterally, if the thermal diffusion length (μ) is large, then the subsurface void 114 which is small may not be detected. In the depth dimensions, if the thermal diffusion length (μ) is too short, then deep perturbations will diffuse and will not be detected.

To accommodate for the limitations associated with the thermal diffusion length (μ), the infrared radiation 103a may be NIR radiation and/or SWIR radiation. The light source 202 may be one of a NIR light source or SWIR light source. The use of the NIR light source and/or the SWIR light source as the heat source for the active thermography in the context inspection of the direct bonds 112 may be beneficial. Using the NIR light source and/or the SWIR light source may allow bringing the NIR radiation and/or the SWIR radiation to the direct bond 112. For example, the semiconductor devices 110 may be at least partially transparent to the NIR radiation and/or transparent to the SWIR radiation. The NIR radiation and/or the SWIR radiation may then be absorbed by the metal layers and/or active layers near the direct bond 112. Thus, the NIR radiation and the SWIR radiation may be partially absorbed and not absorbed, respectively, by the bulk of the semiconductor devices 110 before being absorbed near the direct bond 112. Bringing the heat source 102 close to the direct bond 112 may allow for increased LIT frequency and consequently for increased detection resolution. The NIR light source or the SWIR light source may provide a means to overcome the limitation of the ability to detect the subsurface void 114 due to thermal diffusion length (μ) by bringing the heat source closer to the direct bond 112. By taking advantage of the partial transparency of silicon in the NIR range and/or the transparent in the SWIR range, the infrared radiation 103a may be propagated optically up to the direct bond 112. The lock-in and/or pulse frequency at which the infrared radiation 103a heats the direct bond 112 may also be increased. Thus, the propagation optically up to the direct bond 112 may allow the active thermographic system 100 to increase the modulation frequency and, accordingly, the detection resolution.

The light-based heat source 102a may be configured to generate the infrared radiation 103a at any NIR or SWIR wavelength at or above than 1 micrometer, in which silicon of the semiconductor devices 110 are practically transparent. For example, the infrared radiation 103a may be between 1 and 3 micrometers. NIR or SWIR radiation at or above 1 micrometer may be where silicon transitions from absorbing the infrared radiation 103a to being transparent to the radiation. For example, the semiconductor devices 110 may volumetrically absorb the infrared radiation 103a at 1 micrometer. The infrared radiation 103a may allow for heat deposition at the subsurface void 114, thus allows for improved detectability of the subsurface void 114 which may be smaller than typical thermographic resolution.

The light source 202 may be coupled to direct the infrared radiation 103a onto the lower semiconductor devices 110b. The light-based heat source 102a may include an optical fiber 204 and/or a collimator lens 206. The light source 202 may be coupled, via the optical fiber 204 or in free space, to the collimator lens 206. The collimator lens 206 may direct the infrared radiation 103a onto the lower semiconductor devices 110b. For example, the collimator lens 206 may direct the infrared radiation 103a onto the bottom surface of the lower semiconductor devices 110b. It is further contemplated that the light-based heat source 102a may include other components by which the light source 202 may be coupled to direct the infrared radiation 103a onto the lower semiconductor devices 110b.

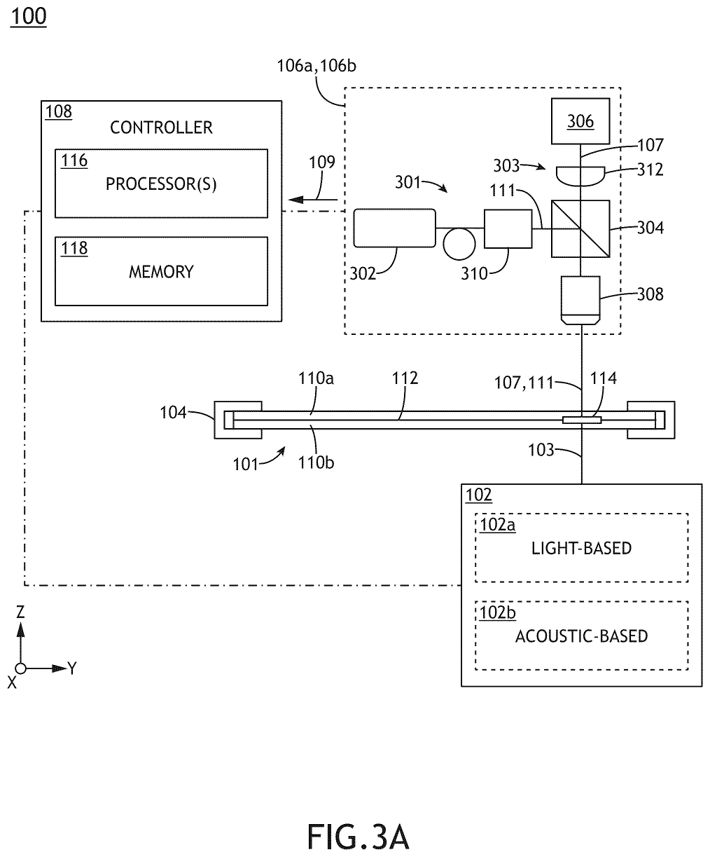

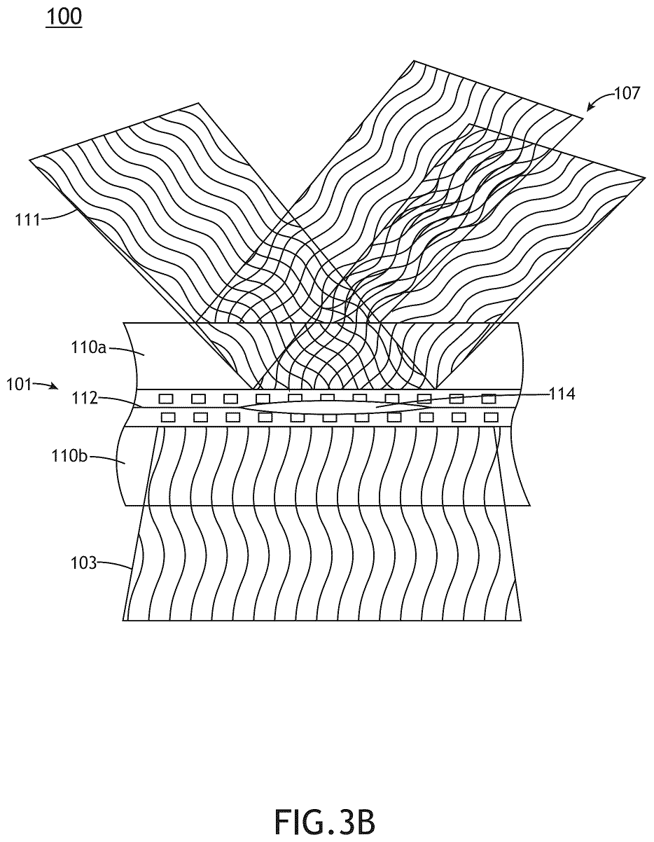

FIGS. 3A-3B depict the active thermographic system 100 with the NIR-imaging subsystem 106a and/or the SWIR-imaging subsystem 106b, in accordance with one or more embodiments of the present disclosure. In this example of the active thermographic system 100, the imaging subsystem 106 is the NIR-imaging subsystem 106a and/or the SWIR-imaging subsystem 106b.

The NIR-imaging subsystem 106a and/or the SWIR-imaging subsystem 106b may include an illumination source 302, a beamsplitter 304, a detector 306, an objective lens 308, illumination optics 310, and/or collection optics 312.

The NIR-imaging subsystem 106a and/or the SWIR-imaging subsystem 106b may include one or more sub-systems. The illumination source 302, the beamsplitter 304, the objective lens 308, and/or the illumination optics 310 may be an illumination sub-system. The beamsplitter 304, the detector 306, the objective lens 308, and/or the collection optics 312 may be a collection sub-system. The illumination sub-system and the collection sub-system may share a common optical path. For example, the illumination sub-system and the collection sub-system may include the objective lens 308 and the beamsplitter 304 in common.

The illumination source 302 may generate the infrared illumination 111. The illumination source 302 may direct the infrared illumination 111 to the direct-bonded stack 101 along an illumination pathway 301.

The illumination pathway 301 may include the illumination optics 310. The illumination source 302 may be coupled, via an optical fiber or in free space, to the illumination optics 310. The illumination optics 310 may be disposed between the illumination source 302 and the beamsplitter 304. The illumination optics 310 may modify and/or condition the infrared illumination 111. For example, the illumination optics 310 may include, but are not limited to, polarizers, filters, beam splitters, diffusers, homogenizers, apodizers, or beam shapers. The illumination optics 310 may also focus the infrared illumination 111. For example, the illumination optics 310 may include one or more illumination pathway lenses for controlling one or more characteristics of the infrared illumination 111. The illumination optics 310 may provide an optical relay (e.g. a pupil relay, or the like), modify the diameter of the infrared illumination 111 (e.g., condense and/or collect), or the like. In embodiments, the illumination optics 310 may include a focusing lens that may focus the infrared illumination 111 into the pupil plane of the objective lens 308 through the beamsplitter 304.

The beamsplitter 304 may be a beam combiner, a splitter/combiner, or the like. The beamsplitter 304 may be positioned in the illumination pathway 301 between the illumination optics 310 and the objective lens 308. The infrared illumination 111 and the collected-infrared light 107 may be on-axis between the beamsplitter 304 and the direct-bonded stack 101, such that a portion of the illumination pathway 301 and the collection pathway 303 may overlap. Although the imaging subsystem 106 is described as including the beamsplitter 304, this is not intended as a limitation of the present disclosure. It is contemplated that the infrared illumination 111 and the collected-infrared light 107 may be off-axis.

The beamsplitter 304 may direct the infrared illumination 111 from the illumination pathway 301 into the objective lens 308. The infrared illumination 111 from the illumination source 302 may pass through the beamsplitter 304. The infrared illumination 111 may be on-axis after passing through the beamsplitter 304. For example, the beamsplitter 304 may combine the infrared illumination 111 such that the infrared illumination 111 is on-axis with the detector 306. The infrared illumination 111 which is on-axis may be in brightfield configuration. In embodiments, the infrared illumination 111 may be made parallel to the optical axis of the objective lens 308 by the beamsplitter 304. The infrared illumination 111 may be configured to pass through the objective lens 308 to the direct-bonded stack 101. The infrared illumination 111 may be directed to the direct-bonded stack 101 in the brightfield configuration. The beamsplitter 304 may also direct the collected-infrared light 107 from the direct-bonded stack 101 to the detector 306 along the collection pathway 303. The beamsplitter 304 may be oriented such that the illumination source 302 may simultaneously direct the infrared illumination 111 to the direct-bonded stack 101 and such that the detector 306 may collect the collected-infrared light 107 reflected from the direct-bonded stack 101.

The objective lens 308 may be disposed between the beamsplitter 304 and the direct-bonded stack 101. The objective lens 308 may include one or more optical elements, which may be reflective, refractive, or both. The infrared illumination 111 and the collected-infrared light 107 may share the objective lens 308. The infrared illumination 111 and the collected-infrared light 107 may pass through the objective lens 308. The objective lens 308 may direct the infrared illumination 111 onto the direct-bonded stack 101. The objective lens 308 may also collect the collected-infrared light 107 from the direct-bonded stack 101.

The detector 306 may receive the collected-infrared light 107 along the collection pathway 303. The collection pathway 303 may include collection optics 312 to direct and/or modify the collected-infrared light 107. For example, the collection optics 312 may include filters, polarizers, beam blocks, imaging apertures, folding mirrors, or the like. The collection optics 312 may be disposed between the beamsplitter 304 and the detector 306. The collection optics 312 may include a tube lens that focuses the collected-infrared light 107 on the detector 306. The tube lens may provide high magnification optics. The tube lens may include spherical positive and negative lenses, abortion compensation optics, zoom mechanisms, and/or other components that translate images to the detector 306.

The detector 306 may receive the collected-infrared light 107 and generate the infrared images 109 based on the collected-infrared light 107. The detector 306 may include any type of optical detector configured to generate an image from the collected-infrared light 107. The detector 306 may be point sensors, line sensors, or array sensors. For example, the detector 306 may include, but are not limited to, a charge-coupled device (CCD) sensor, a time delay integration (TDI) sensor, a photomultiplier tube (PMT), an avalanche photodiode (APD), a complementary metal-oxide-semiconductor (CMOS) sensor, NIR or SWIR sensitive photodiodes, or the like. In embodiments, the detector 306 may be a spectrometer with one or more polarizers to perform spectral ellipsometry. In embodiments, the detector 306 may be a dichroic mirror to perform time-dependent Raman spectroscopy. The detector 306 may be configured to generate any suitable output, such as the infrared images 109.

FIG. 3B depicts the infrared illumination 111 and the collected-infrared light 107 of the active thermographic system 100 with the NIR-imaging subsystem 106a and/or the SWIR-imaging subsystem 106b, in accordance with one or more embodiments of the present disclosure. In embodiments, the illumination source 302 may be a coherent illumination source. For example, the illumination source 302 may be a NIR laser and/or a SWIR laser. The infrared illumination 111 may be a coherent beam. For example, the infrared illumination 111 may be a coherent NIR beam and/or a coherent SWIR beam. The infrared illumination 111 may be the coherent NIR beam and the coherent SWIR beam where the imaging subsystem 106 is the NIR-imaging subsystem 106a and the SWIR-imaging subsystem 106b, respectively. By way of another example, the infrared illumination 111 may be incoherent where the illumination source 302 is an incoherent source, for example a SWIR/NIR LED. Filters may be introduced into the illumination pathway 301 to control the illumination spectral distribution.

The NIR-imaging subsystem 106a and/or the SWIR-imaging subsystem 106b may be configured as a shearing interferometer. For example, the upper semiconductor devices 110a may be a shear plate of the shearing interferometer. The coherent beam may be directed at the upper surface of the direct-bonded stack 101. A portion of the coherent beam may be reflected from the upper surface of the direct-bonded stack 101. A portion of the coherent beam may also be transmitted through the upper semiconductor devices 110a up to the direct bond 112, reflect from the direct bond 112, and transmit through the upper semiconductor devices 110a. The reflected portions of the coherent beam reflected from the upper surface of the direct-bonded stack 101 and from the direct bond 112 may be co-propagated outwards from the direct-bonded stack 101, where the two portions interfere with each other to form the collected-infrared light 107. Assuming a single reflection for simplicity, the interference intensity may be defined by:

$$I ( t ; L ) ∝ 1 + cos [ \frac{4 π}{λ} {\int }_{0}^{L} n ( z ; T [ z , t ] ) dz ]$$

where λ is the wavelength of the infrared illumination 111, L is the thickness of the upper semiconductor devices 110a, n is the refractive index of the semiconductor material of the upper semiconductor devices 110a along the depth coordinate (z). A heat front T[z, t] propagating from the direct bond 112 at time t may cause a change in the refractive index of the semiconductor material, which will translate to an intensity variation of the collected-infrared light 107. The collected-infrared light 107 may be imaged on the detector 306. The variation in the intensity of the collected-infrared light 107 may indicate the change in the refractive index due to the heat front. The intensity of the collected-infrared light 107 is proportional to the interference. Part of the intensity is related to optical path difference inside the cosine term. The optical path difference traveled by the collected-infrared light 107 may control the phase of the collected-infrared light 107 and similarly the fringes of the collected-infrared light 107.

The detection sensitivity is proportional to the gradient of the collected-infrared light 107 when unperturbed, without the subsurface void 114 and/or without temperature modulation from the heat source 102. The gradient of interference intensity (δI) may be defined by:

$$δ I ∝ sin ( \frac{4 π}{λ} {n}_{1} L )$$

Where n1 is the refractive index of the semiconductor material of the upper semiconductor devices 110a when unperturbed, without the subsurface void 114 and/or without temperature modulation from the heat source 102.

For certain values of L the sensitivity may drop to zero. The imaging subsystem 106 may compensate for the thickness of the upper semiconductor devices 110a. To have meaningful detection, the controller 108 may impose variation on the phase of the infrared illumination 111 and/or the collected-infrared light 107 to determine how the phase changes the interference fringes in the collected-infrared light 107.

In embodiments, the illumination source 302 is a tunable laser source (e.g., a tunable NIR laser and/or a tunable SWIR laser) configured generate the infrared illumination 111 having a tunable spectrum. The controller 108 may tune the wavelength (λ) of the infrared illumination 111 to determine how the phase changes the interference fringes in the collected-infrared light 107. For a 0.75 mm thick silicon wafer, the illumination source 302 may be configured to perform wavelength tuning of roughly 0.005% to add a π/2 phase shift in the fringes within the infrared images 109.

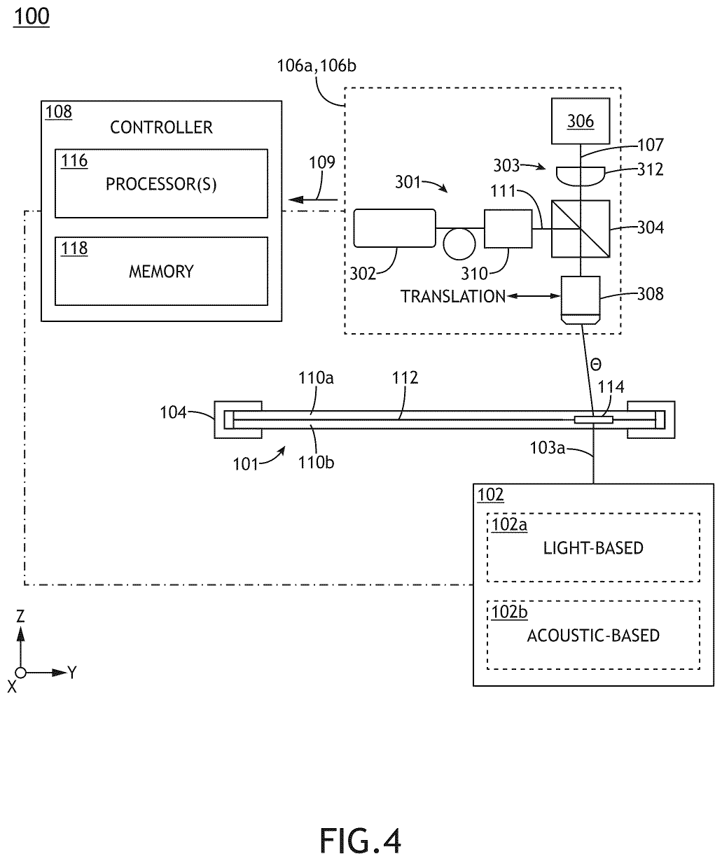

FIG. 4 depicts the active thermographic system 100 with the NIR-imaging subsystem 106a and/or the SWIR-imaging subsystem 106b, in accordance with one or more embodiments of the present disclosure. In embodiments, the controller 108 may be configured to change the angle-of-incidence of the infrared illumination 111 on the direct-bonded stack 101. The controller 108 may be change the angle-of-incidence of the infrared illumination 111 to add a π/2 phase shift in the fringes within the infrared images 109. The angle-of-incidence of the infrared illumination 111 may be changed to shift the unperturbed interference fringe.

Given an angle-of-incidence (θ), the gradient of interference intensity (δI) may be defined by:

$$δ I ∝ sin ( \frac{4 π}{λ} {n}_{1} L cos ( \frac{θ}{{n}_{1}} ) )$$

The controller 108 may change the angle-of-incidence of the infrared illumination 111 to determine how the phase changes the interference fringes in the collected-infrared light 107. For a 0.75 mm thick silicon wafer, the infrared illumination 111 may be changed by 2 degrees to add a π/2 phase shift in the fringes.

The controller 108 may be configured to change the angle-of-incidence of the infrared illumination 111 in any suitable manner. Depending on the optical setup, the angle-of-incidence may be controlled by tilt of one of the mirrors (not depicted) of the imaging subsystem 106 or by translation of one of the lenses in the illumination pathway 301. For example, the controller 108 may be configured to translate the objective lens 308 in the XY plane to change the angle-of-incidence.

In the configuration as the shearing interferometer, the NIR-imaging subsystem 106a and/or the SWIR-imaging subsystem 106b do not include a reference mirror and/or reference beam. Several modifications of the optical setup of the NIR-imaging subsystem 106a and/or the SWIR-imaging subsystem 106b may also be realized including a reference mirror and/or a reference beam to impose the variation on the phase, as described further herein.

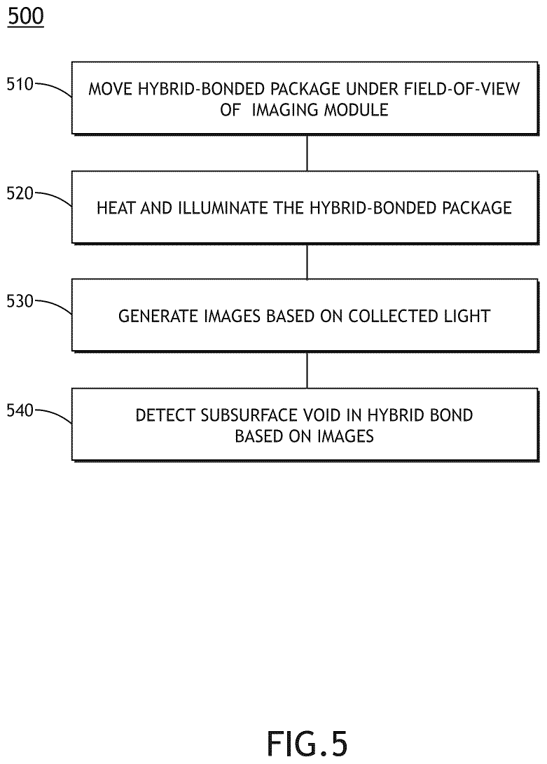

FIG. 5 depicts a flow diagram of a method 500, in accordance with one or more embodiments of the present disclosure. The method 500 may be a method of detecting the subsurface void 114 in the semiconductor devices 110. The method 500 is based upon thermography for detection of sub-surface defects. The method 500 may allow rapid and high-resolution thermal detection based on SWIR imaging. The embodiments and the enabling technologies described previously herein in the context of the active thermographic system 100 should be interpreted to extend to the method 500. For example, the method 500 may be performed using the method 500 with the NIR-imaging subsystem 106a and/or the SWIR-imaging subsystem 106b. It is further noted, however, that the method 500 is not limited to the architecture of the active thermographic system 100.

In a step 510, a stage may move a direct-bonded stack under a field-of-view of an imaging subsystem. For example, the stage 104 may move the direct-bonded stack 101 under a field-of-view of the NIR-imaging subsystem 106a and/or the SWIR-imaging subsystem 106b. The stage 104 may move the direct-bonded stack 101 as the step-and-repeat process or the scanning process.

In a step 520, a heat source and the imaging subsystem may simultaneously heat and illuminate, respectively, the direct-bonded stack. For example, the heat source 102 and one of the NIR-imaging subsystem 106a or the SWIR-imaging subsystem 106b may simultaneously heat and illuminate, respectively, the direct-bonded stack 101 with the heat energy and the infrared illumination 111. The heat source 102 may be the light-based heat source 102a which heats the direct-bonded stack 101 by the infrared radiation 103a. The light-based heat source 102a and one of the NIR-imaging subsystem 106a or the SWIR-imaging subsystem 106b may be configured for transmissive thermography such that the infrared radiation 103a and the infrared illumination 111 are on opposing sides of the direct-bonded stack 101. The infrared radiation 103a may generate the modulated heat front along the direct bond 112 corresponding to the subsurface void 114. The infrared radiation 103a may be modulated via lock-in thermography in which the infrared radiation 103a is applied as a sinusoid. Alternatively, the infrared radiation 103a may be modulated via pulse thermography where the infrared radiation 103a may be modulated via pulses. Alternatively, any arbitrary time modulation sequence of the infrared radiation 103a may be adopted.

In a step 530, the imaging subsystem may generate images based on collected-infrared light in response to the infrared illumination. For example, the detector 306 of the NIR-imaging subsystem 106a or the SWIR-imaging subsystem 106b may generate the infrared images 109 based on the collected-infrared light 107 in response to the infrared illumination 111. The infrared images 109 may include intensity (e.g., interference fringes) indicating a time-dependent temperature of the direct bond 112 based on the change in the refractive index due to temperature.

In a step 540, a controller may receive the infrared images and detect the subsurface void in the direct bond based on the infrared images. For example, the controller 108 may receive the infrared images 109 and detect the subsurface void 114 in the direct bond 112 based on the infrared images 109. Where the infrared images 109 are generated as part of a scanning process, the controller 108 may register the infrared images 109 together for alignment purposes.

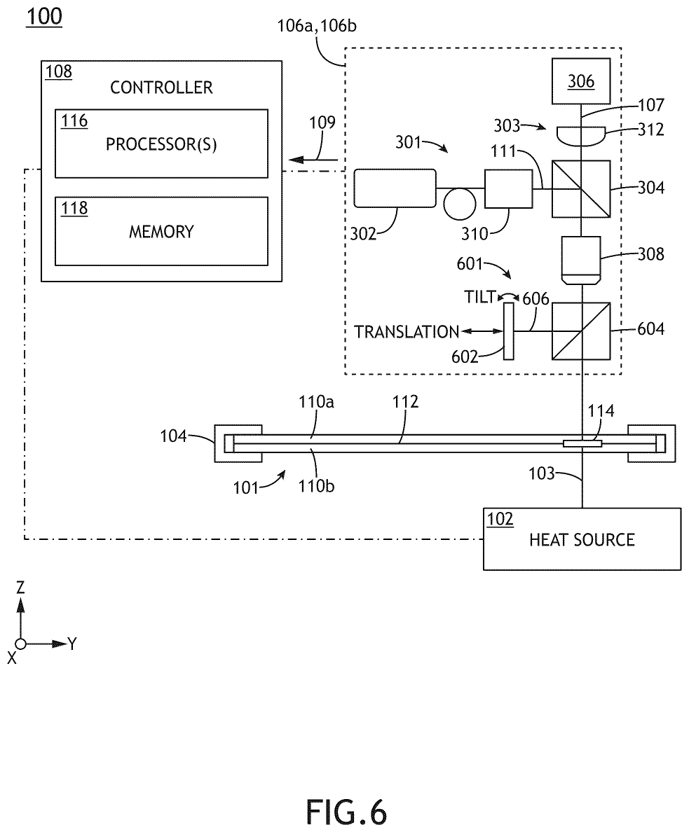

FIG. 6 depicts the active thermographic system 100 with the NIR-imaging subsystem 106a and/or the SWIR-imaging subsystem 106b, in accordance with one or more embodiments of the present disclosure.

Although the NIR-imaging subsystem 106a and/or the SWIR-imaging subsystem 106b are described as configured as a shearing interferometer, the illumination source 302 is described as a coherent illumination source, and the infrared illumination 111 is described as a coherent beam, this is not intended as a limitation of the present disclosure. The NIR-imaging subsystem 106a and/or the SWIR-imaging subsystem 106b may be configured to prevent the upper semiconductor devices 110a from functioning as a shear plate. A coherence length of the infrared illumination 111 may be sufficiently low to prevent the reflected portions of the infrared illumination 111 reflected from the upper surface of the direct-bonded stack 101 and from the direct bond 112 to interfere with each other to form the collected-infrared light 107. For example, the coherence length of the infrared illumination 111 may avoid interfering signals from the upper surface of the direct-bonded stack 101. For a typical 0.75 mm thick silicon wafer, the coherence length of the infrared illumination 111 may be less than 5 mm to prevent the shearing interference. For example, the illumination source 302 may be a NIR LED, a SWIR LED, a short-coherence length NIR laser, a short-coherence length SWIR laser, or the like.

In embodiments, the NIR-imaging subsystem 106a and/or the SWIR-imaging subsystem 106b may be configured as a double-path interferometer. The NIR-imaging subsystem 106a and/or the SWIR-imaging subsystem 106b may include a reference mirror 602 and/or a reference beamsplitter 604. The reference beamsplitter 604 may split the infrared illumination 111 from the illumination pathway 301 as a reference beam 606 into a reference path 601. A remaining portion of the infrared illumination 111 may transmit through the reference beamsplitter 604 along the illumination pathway 301 to the direct-bonded stack 101. The reference beam 606 may reflect from the reference mirror 602 and return to the reference beamsplitter 604. The reference beamsplitter 604 may combine the reference beam 606 with the collected-infrared light 107 into the collection pathway 303. For example, the reference beamsplitter 604 may combine the reference beam 606 with the portion of the infrared illumination 111 reflecting from the direct bond 112 and interfere to form the collected-infrared light 107. The reference path 601 in combination with the portion of the illumination pathway 301 and/or collection pathway 303 below the reference beamsplitter 604 may form the two paths of the double-path interferometer.

The reference mirror 602 and reference beamsplitter 604 may be positioned individually. For example, the reference beamsplitter 604 may be positioned between the objective lens 308 and the direct-bonded stack 101. By way of another example, the objective lens 308 may be positioned between the reference beamsplitter 604 and the direct-bonded stack 101. Alternatively, the reference mirror 602 and the reference beamsplitter 604 may be integrated with the objective lens 308. For example, the objective lens 308 may be a Mirau objective or Michelson objective with the reference mirror 602 and reference beamsplitter 604.

The controller 108 may be configured to control the optical path difference and/or the phase between the infrared illumination 111 on the direct bond 112 and the reference beam 606. The optical path difference and/or the phase may be controlled by translation and/or by tilting the reference mirror 602.

In embodiments, the controller 108 may be configured to translate the reference mirror 602. The controller 108 may translate the reference mirror 602 until the optical path difference from reference beam 606 and the portion of the infrared illumination 111 reflecting from the direct bond 112 is zero or near zero. For example, the controller 108 may translate the reference mirror 602 to add a π/2 phase shift in the fringes within the infrared images 109.

In embodiments, the controller 108 may be configured to tilt the reference mirror 602. The interference pattern between the infrared illumination 111 and the reference beam 606 in the infrared images 109 may represent a hologram of the direct bond 112 and may be analyzed by the controller 108 in terms of digital holography.

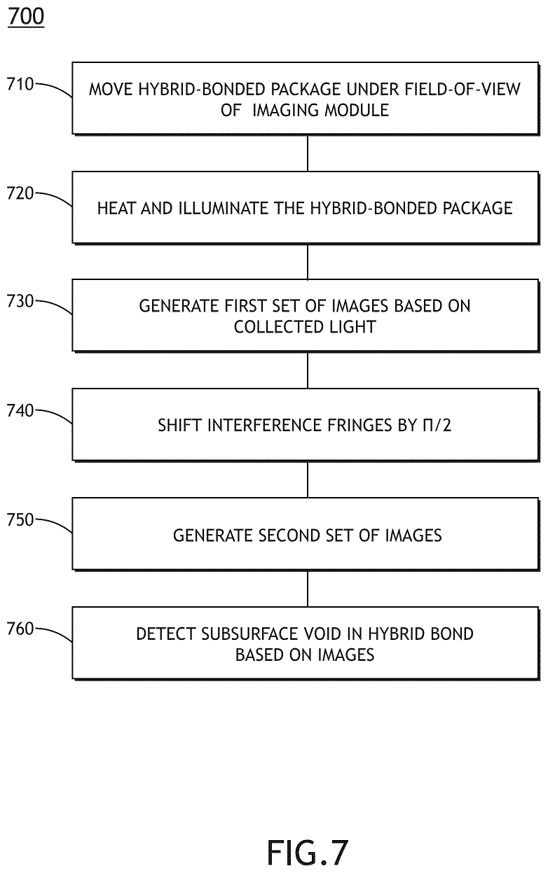

FIG. 7 depicts a flow diagram of a method 700, in accordance with one or more embodiments of the present disclosure. The embodiments and the enabling technologies described previously herein in the context of the active thermographic system 100 and/or the method 500 should be interpreted to extend to the method 700. It is further noted, however, that the method 700 is not limited to the architecture of the active thermographic system 100 and/or the method 500.

In a step 710, a stage may move a direct-bonded stack under a field-of-view of an imaging subsystem. For example, the stage 104 may move the direct-bonded stack 101 under a field-of-view of the NIR-imaging subsystem 106a and/or the SWIR-imaging subsystem 106b. The stage 104 may move the direct-bonded stack 101 as the step-and-repeat process or the scanning process.

In a step 720, a heat source and the imaging subsystem may simultaneously heat and illuminate, respectively, the direct-bonded stack. For example, the heat source 102 and one of the NIR-imaging subsystem 106a or the SWIR-imaging subsystem 106b may simultaneously heat and illuminate, respectively, the direct-bonded stack 101 with the heat energy and the infrared illumination 111.

In a step 730, the imaging subsystem may generate a first set of infrared images based on collected-infrared light in response to the infrared illumination. For example, the detector 306 of the NIR-imaging subsystem 106a or the SWIR-imaging subsystem 106b may generate the first set of the infrared images 109 based on the collected-infrared light 107 in response to the infrared illumination 111. The collected-infrared light 107 may be the combination of the reflected portions of the coherent beam reflected from the upper surface of the direct-bonded stack 101 and from the direct bond 112, where the NIR-imaging subsystem 106a and/or the SWIR-imaging subsystem 106b are configured as the shearing interferometer. Alternatively, the collected-infrared light 107 may be the combination of the reference beam 606 with the portion of the infrared illumination 111 reflecting from the direct bond 112, where the NIR-imaging subsystem 106a and/or the SWIR-imaging subsystem 106b are configured as the double-path interferometer.

In a step 740, interference fringes of the collected-infrared light may be shifted by up to π/2. For example, the controller 108 may cause the NIR-imaging subsystem 106a or the SWIR-imaging subsystem 106b to shift the interference fringes of the collected-infrared light 107 by up to π/2. The interference fringes of the collected-infrared light 107 may be shifted by up to π/2 by tuning the wavelength of the infrared illumination 111 using the illumination source 302, by changing the angle-of-incidence of the infrared illumination 111 on the direct-bonded stack 101 (e.g., by translating the objective lens 308), and/or by translating and/or tilting the reference mirror 602.

In a step 750, the imaging subsystem may generate a second set of infrared images based on collected-infrared light in response to shifting the interference fringes of the collected-infrared light by up to π/2. For example, the detector 306 of the NIR-imaging subsystem 106a or the SWIR-imaging subsystem 106b may generate the second set of the infrared images 109 based on the collected-infrared light 107 in response to shifting the interference fringes of the collected-infrared light 107 by up to π/2. Thus, the interference fringes in the first set and second set of the infrared images 109 may be alternated between brightest intensities and darkest intensities.

In a step 760, a controller may receive the first set and second set of infrared images and detect the subsurface void in the direct bond based on the infrared images. For example, the controller 108 may receive the first set and second set of the infrared images 109 and detect the subsurface void 114 in the direct bond 112 based on the infrared images 109. The controller 108 may detect the thermal response through phase or polarization change of the collected-infrared light 107, thereby detecting the subsurface void 114.

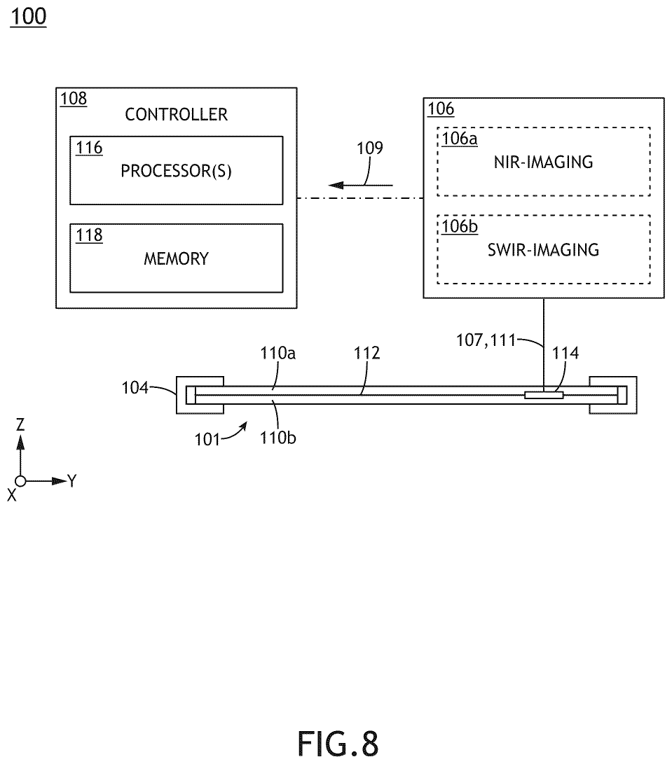

FIG. 8 depicts an optical inspection system 800, in accordance with one or more embodiments of the present disclosure. The discussion of the active thermographic system 100 is incorporated herein by reference as to the optical inspection system 800. The optical inspection system 800 may include the stage 104, the imaging subsystem 106 (e.g., the NIR-imaging subsystem 106a and/or the SWIR-imaging subsystem 106b), and/or the controller 108. The optical inspection system 800 may not include the heat source 102. The optical inspection system 800 may be operated without the heat source 102.

The optical inspection system 800 may be configured to detect the subsurface void 114 in the direct bond 112 using the NIR-imaging subsystem 106a and/or the SWIR-imaging subsystem 106b based on deformations of the upper semiconductor devices 110a caused by the subsurface void 114. The NIR-imaging subsystem 106a and/or the SWIR-imaging subsystem 106b may be operated without the heat source 102 because the collected-infrared light 107 may be highly sensitive to the device topography.

The optical inspection system 800 may be configured to detect the subsurface void 114 in the direct bond 112 using the NIR-imaging subsystem 106a and/or the SWIR-imaging subsystem 106b based on internal stresses in the upper semiconductor devices 110a. For example, the internal stresses may be detected by configuring the optical inspection system 800 to detect changes in the polarization of the collected-infrared light 107 (e.g., the SWIR/NIR light) caused by stress-induced birefringence in the semiconductor devices 110a at the vicinity of the subsurface void 114.

Similarly, the active thermographic system 100 may detect the subsurface void 114 using the NIR-imaging subsystem 106a and/or the SWIR-imaging subsystem 106b based on deformations of the upper semiconductor devices 110a and/or internal stress detection and then verify the detection by using the heat source 102 to change the temperature of the direct bond 112, for further imaging. The combination of measuring the thickness with the thermal modulation may provide a high fidelity and sensitivity for the detecting the subsurface void 114.

Referring generally again to the figures. The same measurement principle of the active thermographic system 100 and/or the optical inspection system 800, with certain modifications, may be used for other applications besides the direct-bonded stack 101, such as the detection of the subsurface void 114 in through-silicon vias (TSVs), in interposer layers of packaged semiconductors, in a delamination of glass substrates, and/or in a delamination of multilayer printed circuit boards.

The MWIR-imaging subsystem 106c and/or the LWIR-imaging subsystem 106d may be like the NIR-imaging subsystem 106a and/or the SWIR-imaging subsystem 106b. For example, the MWIR-imaging subsystem 106c and/or the LWIR-imaging subsystem 106d may include the detector 306, the objective lens 308, and/or the collection optics 312. The detector 306 of the MWIR-imaging subsystem 106c and/or the LWIR-imaging subsystem 106d may be configured to detect the collected-infrared light 107 in the MWIR and LWIR bands, respectively. The MWIR-imaging subsystem 106c and/or the LWIR-imaging subsystem 106d may not include the illumination source 302, the beamsplitter 304, and/or the illumination optics 310 because the MWIR-imaging subsystem 106c and/or the LWIR-imaging subsystem 106d may not generate the infrared illumination 111.

A controller may include one or more controllers housed in a common housing or within multiple housings. In this way, any controller or combination of controllers may be separately packaged as a module suitable for integration into a system. Further, the controllers may analyze data received from detectors and feed the data to additional components within the system or external to the system.

It is further contemplated that each of the embodiments of the methods described above may include any other step(s) of any other method(s) described herein. In addition, each of the embodiments of the method described above may be performed by any of the systems described herein.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected,” or “coupled,” to each other to achieve the desired functionality, and any two components capable of being so associated can also be viewed as being “couplable,” to each other to achieve the desired functionality. Specific examples of couplable include but are not limited to physically mixable and/or physically interacting components and/or wirelessly interactable and/or wirelessly interacting components and/or logically interacting and/or logically interactable components.

Furthermore, it is to be understood that the invention is defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” and the like). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, and the like” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, and the like). In those instances where a convention analogous to “at least one of A, B, or C, and the like” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, and the like). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. An active thermographic system comprising:
a stage configured to support a direct-bonded stack, wherein the direct-bonded stack includes an upper semiconductor device and a lower semiconductor device, wherein the upper semiconductor device and the lower semiconductor device are coupled by a direct bond;
a heat source configured to heat the direct bond;
an imaging subsystem configured to generate a plurality of infrared images of the direct bond from collected-infrared light; and
a controller, wherein the controller includes one or more processors configured to execute program instructions maintained in memory, the program instructions causing the one or more processors to:
receive the plurality of infrared images from the imaging subsystem; and
detect a subsurface void in the direct bond based on the plurality of infrared images.

2. The active thermographic system of claim 1, wherein the heat source is a light-based heat source, wherein the light-based heat source is configured to generate infrared radiation, wherein the infrared radiation is configured to heat the direct bond.

3. The active thermographic system of claim 2, wherein the infrared radiation is at least one of near-infrared or short-wave infrared.

4. The active thermographic system of claim 3, wherein the infrared radiation is at or above 1 micrometer.

5. The active thermographic system of claim 3, wherein the active thermographic system is configured for one of lock-in thermography or pulse thermography, wherein the controller is configured to synchronize the heat source and the imaging subsystem.

6. The active thermographic system of claim 5, wherein the light-based heat source and the imaging subsystem are disposed on opposing sides of the direct-bonded stack.

7. The active thermographic system of claim 3, wherein the light-based heat source comprises a light source, wherein the light source is one of a laser, a light-emitting diode, or a lamp.

8. The active thermographic system of claim 1, wherein the active thermographic system is configured for vibro-thermography, wherein the heat source is an acoustic-based heat source configured to generate acoustic waves, wherein the acoustic waves are configured to heat the subsurface void.

9. The active thermographic system of claim 1, wherein the controller is configured to cause the imaging subsystem to generate the plurality of infrared images as one of a step-and-repeat process or a scanning process.

10. The active thermographic system of claim 1, wherein the collected-infrared light is emitted by the direct bond in response to being heated by the heat source, wherein the collected-infrared light is emitted as one of mid-wave infrared or long-wave infrared.

11. The active thermographic system of claim 1, wherein the imaging subsystem is configured to illuminate the direct bond with infrared illumination, wherein the infrared illumination reflects from the direct bond as the collected-infrared light, wherein the infrared illumination is one of near-infrared illumination or short-wave infrared illumination.

12. The active thermographic system of claim 11, wherein the infrared illumination is between 1 and 1.7 micrometers.

13. The active thermographic system of claim 11, wherein a power of the infrared illumination is at least two orders of magnitude smaller than a power of heat energy from the heat source.

14. The active thermographic system of claim 11, wherein the imaging subsystem comprises:
an illumination source configured to generate the infrared illumination and direct the infrared illumination along an illumination pathway to the direct-bonded stack and reflect as the collected-infrared light, wherein the collected-infrared light is formed via interferometry; and
a detector, wherein the collected-infrared light is directed to the detector along a collection pathway including an objective lens, wherein the detector is configured to receive the collected-infrared light and generate the plurality of infrared images.

15. The active thermographic system of claim 14, comprising a beamsplitter, wherein the beamsplitter is configured to direct the infrared illumination into the objective lens, wherein the infrared illumination is configured to pass through the objective lens to the direct-bonded stack.

16. The active thermographic system of claim 14, wherein the imaging subsystem comprises one or more illumination optics disposed in the illumination pathway, wherein the one or more illumination optics comprise a focusing lens.

17. The active thermographic system of claim 14, wherein the imaging subsystem comprises one or more collection optics disposed in the collection pathway, wherein the one or more collection optics comprise a tube lens.

18. The active thermographic system of claim 14, wherein the detector is one of a point sensor, a line sensor, or an array sensor.

19. The active thermographic system of claim 14, wherein the illumination source is a coherent illumination source, wherein the imaging subsystem is configured as a shearing interferometer, wherein the upper semiconductor device is a shear plate.

20. The active thermographic system of claim 19, wherein the active thermographic system is configured to:
move the direct-bonded stack under a field-of-view of the imaging subsystem by the stage;
simultaneously heat and illuminate the direct-bonded stack by the heat source and the imaging subsystem, respectively; and
generate the plurality of infrared images by the imaging subsystem.

21. The active thermographic system of claim 14, wherein the illumination source is a tunable illumination source, wherein the controller is configured to tune a wavelength of the infrared illumination to add a phase shift of up to π/2 in fringes within the plurality of infrared images.

22. The active thermographic system of claim 14, wherein the controller is configured to change an angle-of-incidence of the infrared illumination on the direct-bonded stack to add a phase shift of up to π/2 in fringes within the plurality of infrared images.

23. The active thermographic system of claim 22, wherein the controller is configured to translate the objective lens to change the angle-of-incidence.

24. The active thermographic system of claim 14, wherein the imaging subsystem is configured as a double-path interferometer, wherein the imaging subsystem comprises a reference mirror and a reference beamsplitter, wherein the reference beamsplitter is configured to split the infrared illumination as a reference beam into a reference path, wherein the reference beam is configured to reflect from the reference mirror and return to the reference beamsplitter, wherein the reference beamsplitter is configured to combine the reference beam with the collected-infrared light into the collection pathway.

25. The active thermographic system of claim 24, wherein the controller is configured to translate the reference mirror to add a phase shift of up to π/2 in fringes within the plurality of infrared images.

26. The active thermographic system of claim 24, wherein the controller is configured to tilt the reference mirror.

27. The active thermographic system of claim 24, wherein the active thermographic system is configured to:
move the direct-bonded stack under a field-of-view of the imaging subsystem by the stage;
simultaneously heat and illuminate the direct-bonded stack by the heat source and the imaging subsystem, respectively;
generate a first set of the plurality of infrared images by the imaging subsystem;
shift interference fringes of the collected-infrared light by up to π/2 by the imaging subsystem; and
generate a second set of the plurality of infrared images by the imaging subsystem.

28. An optical inspection system comprising:
a stage configured to support a direct-bonded stack, wherein the direct-bonded stack includes an upper semiconductor device and a lower semiconductor device, wherein the upper semiconductor device and the lower semiconductor device are coupled by a direct bond, wherein the direct bond includes a subsurface void;
an imaging subsystem configured to generate a plurality of infrared images of the direct bond from collected-infrared light, wherein the imaging subsystem is configured to illuminate the direct bond with infrared illumination, wherein the infrared illumination reflects from the direct bond as the collected-infrared light, wherein the infrared illumination is one of near-infrared illumination or short-wave infrared illumination, wherein the imaging subsystem comprises:
an illumination source configured to generate the infrared illumination and direct the infrared illumination along an illumination pathway to the direct-bonded stack and reflect as the collected-infrared light, wherein the collected-infrared light is formed via interferometry; and
a detector, wherein the collected-infrared light is directed to the detector along a collection pathway including an objective lens, wherein the detector is configured to receive the collected-infrared light and generate the plurality of infrared images; and
a controller, wherein the controller includes one or more processors configured to execute program instructions maintained in memory, the program instructions causing the one or more processors to:
receive the plurality of infrared images from the imaging subsystem; and
detect the subsurface void in the direct bond based on the plurality of infrared images.

29. The optical inspection system of claim 28, wherein the illumination source is a coherent illumination source, wherein the imaging subsystem is configured as a shearing interferometer, wherein the upper semiconductor device is a shear plate.

30. The optical inspection system of claim 28, wherein the imaging subsystem is configured as a double-path interferometer, wherein the imaging subsystem comprises a reference mirror and a reference beamsplitter, wherein the reference beamsplitter is configured to split the infrared illumination as a reference beam into a reference path, wherein the reference beam is configured to reflect from the reference mirror and return to the reference beamsplitter, wherein the reference beamsplitter is configured to combine the reference beam with the collected-infrared light into the collection pathway.

31. The optical inspection system of claim 28, wherein the optical inspection system is configured to detect the subsurface void based on internal stresses in the upper semiconductor device.
